(19) United States
(12) Patent Application Publication
(10) Pub. No.: US 2026/0084502 A1
(43) Pub. Date: Mar. 26, 2026

(54) DOOR ASSEMBLY FOR A ROAD VEHICLE

(71) Applicant: Ford Global Technologies, LLC, Dearborn, MI (US)

(72) Inventors: Luis Hoeks, Eschweiler (DE); Christoph Hallet, Bergisch Gladbach (DE); Michael Lohrum, Dieburg (DE); Raja Raghava Sreepathy, Leverkusen (DE); Andrea Schuetze, Köln (DE); Johannes Laprell, Heinsberg (DE)

(21) Appl. No.: 19/335,445

(22) Filed: Sep. 22, 2025

(30) Foreign Application Priority Data
Sep. 26, 2024 (DE) 102024127888.9

(51) Int. Cl. B60J 5/10; B60J 10/50

(52) U.S. Cl. CPC B60J 5/108; B60J 10/50

(57) ABSTRACT

A door assembly for a road vehicle has a first bodyshell element and a second bodyshell element, at least one of which is designed as a door element, wherein in a closed position a contour of the first bodyshell element extends, in a shear region, adjacent to the second bodyshell element along a shear axis, and having a coupling device, which has a first coupling part connected to the first bodyshell element and has a second coupling part connected to the second bodyshell element. To limit torsional vibrations in a road vehicle, in the closed position a middle element of the first coupling part is received, on both sides in relation to the shear axis, form-fittingly between a first contact element and a second contact element of the second coupling part. At least one contact element and the middle element are preloaded against one another.

### CROSS-REFERENCE TO RELATED APPLICATIONS

This disclosure claims priority to German Patent Application No. 102024127888.9, which was filed on 26 Sep. 2024 and is incorporated herein by reference in its entirety.

### TECHNICAL FIELD

The disclosure relates to a door assembly for a road vehicle having a shear region and, more particularly, to a coupling device of the door assembly.

### BACKGROUND

In motor vehicles such as passenger cars or light trucks, the passenger cell, the load compartment or the engine bay is closable by means of at least one door or flap. This can also be referred to as a closure element. In the closed state, the door is secured either on a static bodyshell part or on a further door. In the case of two rear doors of a delivery vehicle, a relative movement between the two elements may be possible. For example, the closing edge extends vertically, that is to say along the vertical axis of the vehicle, and a vertical displacement of the two doors relative to one another is possible. Such a displacement occurs in particular if the vehicle is twisted about the longitudinal axis. This may take place under static conditions but in particular also under dynamic conditions, in the form of a torsional vibration. With regard to said torsional vibration, the first global torsion mode is of particular relevance. The natural frequency thereof lies in the range of the vertical wheel vibration frequency, that is to say the frequency with which the wheels, as part of the unsprung mass, tend to vibrate.

DE 10 2011 079 869 B4 discloses a frequency-independent absorber for damping vibrations of a motorcycle handlebar, wherein the frequency-independent absorber is formed as a motorcycle handlebar end piece for positioning on an outer end of the motorcycle handlebar. The absorber has a closed hollow chamber and loose material, comprising a number of individual elements, arranged in said chamber. A recess having an internal thread is arranged on the outer end.

EP 2 899 092 A1 discloses a swinging-sliding door module for a rail vehicle, having at least one door leaf and having a door drive system which is coupled to the door leaf and which effects a setting-out movement and a displacement movement of the door leaf. The door drive system has at least a first over-center locking means which acts in the setting-out direction of the door leaf and which in the closed position is moved beyond a dead center by an over-center distance or over-center angle. The swinging-sliding door module is designed in terms of its dynamic behavior such that a deflection of the first over-center locking means under the dynamic loads that occur in the rail vehicle during operation is always less than the aforementioned over-center distance or over-center angle.

U.S. Pat. No. 8,038,540 B2 has disclosed a vibration absorber for attachment by clamping to the outer circumference of a rotating shaft. The vibration absorber has an inner part composed of flexible material for lying against the outer circumference of the shaft, and has an outer part which has at least two segments and which engages around and lies vibrationally against the inner part. At their two ends in the circumferential direction, the segments are configured with connecting elements, formed integrally therewith, for establishing a connection. The respective connecting elements have at least two projections of complementary design and extending in the circumferential direction of the outer circumference, said projections each having lugs which extend in a radial direction and engage behind one another, and the inner part has, on each of its ends, a protrusion for fixing the segments in the longitudinal direction of the shaft.

WO 2017/084665 A2 discloses an engine support for supporting an internal combustion engine, comprising a clamping element blocking unit having two switching states, a housing arranged radially outside the clamping element blocking unit, and a rod, wherein, in the open switching state, the rod is linearly displaceable relative to the housing and, in the closed switching state, a relative linear displacement between the rod and the housing is blocked. The clamping element blocking unit has two clamping element cages, which are arranged axially adjacent to one another and in which a plurality of clamping elements are guided, and has at least one spring, wherein the blocking action arises by means of an axial displacement of the clamping element cages relative to one another.

CN 115 898 203 A discloses a side door system assembly. This has a door frame assembly, having a crossmember and having a first pillar and a second pillar that are fastened to the ends of the crossmember. A door panel assembly is attached rotatably to the first pillar, a door locking assembly is installed between the first pillar and the door panel assembly, and a reinforcement rib assembly has a plurality of reinforcement ribs, wherein each of the reinforcement ribs is arranged parallel to the width direction of the door panel assembly. At least one of the reinforcement ribs is arranged on the top and on the bottom of the door panel assembly, and at least one of the reinforcement ribs is between the top side and the bottom side of the door panel assembly.

### SUMMARY

Embodiments of this disclosure limit torsional vibrations in a road vehicle.

An example embodiment includes a door assembly for a road vehicle. The road vehicle may be a motor vehicle such as a passenger car or in particular a truck, which includes delivery vans. The road vehicle may however also be a trailer without a dedicated traction drive.

The door assembly has a first bodyshell element and a second bodyshell element, at least one of which is designed as a door element. The term “door element” refers to a movable element that can be selectively opened and closed in order to allow or prevent access to a vehicle interior compartment. In the closed position the door element closes an access opening to the vehicle interior compartment. Said vehicle interior compartment may be a passenger cell or a load compartment. Here, however, the term “vehicle interior compartment” also encompasses an engine bay, with the door element being designed as a hood. In particular, the door element may allow access to the vehicle interior compartment from the rear, in which case it may also be referred to as a rear door element. The term “close” is not to be understood in the sense of a fluid-tight closure, but rather refers to the fact that access to the vehicle interior compartment via the corresponding access opening is not possible for a user when the door assembly is in the closed position. The door element may in particular be pivotably connected to a vehicle body, though a displaceable connection, for example in the manner of a sliding door, would alternatively or additionally also be possible. A pivot axis of the door element may in particular extend horizontally or vertically. In some embodiments, the terms “tailgate”, “load compartment flap” or “luggage compartment flap” may be used. In some embodiments, the other bodyshell element is also a door element; in other embodiments, it is rigidly connected to the vehicle body and forms, for example, a frame of the door element.

In a closed position a contour of the first bodyshell element extends, in a shear region, adjacent to the second bodyshell element along a shear axis. The contour of the first bodyshell element extends, in the shear region, along the shear axis, and in particular may extend parallel to the shear axis there. In other regions, the course of said contour may deviate significantly from the shear axis. In the closed position the contour is arranged adjacent to the second bodyshell element. In some embodiments, an opposite contour of the second bodyshell element extends, in the shear region, parallel to the contour of the first bodyshell element. The contour may correspond to a dividing line between the two bodyshell elements. The terms “shear region” and “shear axis” are not to be interpreted as limiting, but merely indicate that, in the presence of corresponding acting forces, a shear displacement could occur between the bodyshell elements along the shear axis, because this corresponds to the course of the contour. In many cases, the shear axis extends at an angle with respect to a torsion axis about which the vehicle body could perform a torsional vibration. Shearing between the bodyshell elements could thus occur about said torsion axis in particular in the event of a torsional vibration of the vehicle.

The door assembly furthermore has a coupling device, which has a first coupling part connected to the first bodyshell element and has a second coupling part connected to the second bodyshell element. Each of the coupling parts may also be referred to as a coupling arrangement or coupling device part, and in some embodiments also as a coupling module or as a coupling element. Each coupling part is connected to one of the bodyshell elements, preferably such that the connection is maintained even outside the closed position. The connection may be entirely or partially rigid or movable.

According to the exemplary embodiment, in the closed position a middle element of the first coupling part is received, on both sides in relation to the shear axis, form-fittingly between a first contact element and a second contact element of the second coupling part, wherein at least one contact element is preloaded against the middle element. This means that the second coupling part has two contact elements, which in the closed position enclose the middle element of the first coupling part between them. The contact elements are arranged on both sides of the coupling part in relation to the shear axis, that is to say the middle element is thus arranged in the middle. Both contact elements are preferably in contact with the middle element in the closed position. At least one contact element and the middle element are preloaded against one another. This wording is to be understood, in accordance with the principle “actio=reactio”, to mean that the contact element is preloaded against the middle element and/or the middle element is preloaded against the contact element. This means that these elements are in contact, and a force additionally acts between the two elements owing to a preload. The preload is based on an elastic deformation of one of the elements or of a further element to which the contact element or the middle element is connected. The preload ensures force-transmitting coupling between the contact element and middle element, and thus also corresponding coupling between the first and second bodyshell elements. Shearing along the shear axis is thus possible, but only counter to the preload. Altogether, the coupling device ensures a play-free but elastic connection of the bodyshell elements. Said bodyshell elements can therefore no longer move independently of one another in the event a torsional vibration. This in turn influences the natural frequency of the torsional vibration, in particular that of the first global torsion mode. Through suitable configuration of the coupling device, this natural frequency can be separated from the vertical wheel vibration frequency to an extent sufficient to achieve that the natural vibration of the wheels does not excite the torsional vibration of the vehicle.

The shear axis preferably extends at an angle with respect to a vehicle longitudinal axis, that is to say non-parallel with respect thereto. Said shear axis advantageously extends at an angle of at least 30° with respect to the vehicle longitudinal axis. Said shear axis may be inclined relative to the vehicle longitudinal axis toward the vehicle vertical axis and/or toward the vehicle transverse axis, which includes the possibility that said shear axis extends parallel to one of the latter axes. Thus, in particular in the event of a torsional vibration of the vehicle, shearing between the bodyshell elements could thus occur about its vehicle longitudinal axis. In this case, the vehicle longitudinal axis represents the aforementioned torsion axis. Furthermore, the angle with respect to the vehicle longitudinal axis may be at least 45°. The shear axis preferably extends at an angle of 60° to 90° with respect to the vehicle longitudinal axis. The angle may furthermore lie between 70° and 90°, between 80° and 90°, or between 85° and 90°. In particular, the shear axis may extend parallel to the vehicle transverse axis or to the vehicle vertical axis.

One embodiment provides for the second coupling part to have a first holding element which is fixed in position on the second bodyshell element with respect to the shear axis, wherein the first contact element is deflectable along the shear axis, and preloaded in the direction of the middle element, relative to the first holding element. The first holding element is fixed in position on the second bodyshell element with respect to the shear axis. Said first holding element may in particular also be fixed in position perpendicularly to the shear axis. Said first holding element may for example be screwed, riveted, adhesively bonded or welded to the second bodyshell element. It may be of inelastic form insofar as it deforms at most to a negligible extent under the forces that act during normal operation. The first contact element is deflectable relative to the first holding element along the shear axis, specifically preferably parallel to the shear axis. Said first contact element is furthermore preloaded relative to the first holding element in the direction of the middle element. A preloading force thus acts on the contact element, forcing said contact element in the direction of the middle element. This is the case at least in the closed position, wherein it would be possible for the preload to be eliminated or at least reduced outside the closed position. The first contact element may be at least partially received in a recess of the first holding element. In addition or alternatively, said first contact element may be movably guided on the first holding element, which includes the possibility of said first contact element being guided movably in the recess by way of a partial form fit with the holding element. By way of a form fit with the first contact element, the first holding element may define an end position of the first contact element, beyond which the latter cannot be moved even by the preloading force.

One refinement provides for the second coupling part to have a second holding element which is fixed in position on the second bodyshell element with respect to the shear axis, wherein the second contact element is deflectable along the shear axis, and preloaded in the direction of the middle element, relative to the second holding element. The second holding element may be of identical or mirror-symmetrical design with respect to the first holding element. The second contact element may likewise be of identical or mirror-symmetrical design with respect to the first contact element. In this case, too, the second contact element may be at least partially received in a recess of the second holding element. Said second contact element may be movably guided on the second holding element. The above statements relating to the first holding element and the first contact element are transferable to the second holding element and the second contact element.

In a structurally simpler refinement, the second contact element is fixed in position on the second bodyshell element with respect to the shear axis. Here, said second contact element may be of inelastic form insofar as it deforms at most to a negligible extent under the forces imparted by the middle portion during normal operation. A certain non-negligible elasticity of the second contact element would however also be possible. In any case, the oppositely situated, elastically preloaded first contact element causes the middle portion to be pushed against the second contact element, which is fixed in position, and to thus be secured.

It is conceivable for a contact element to be of elastic form or to have at least one elastic portion. In this case, the preload of the contact element may result from its own elastic deformation. In another refinement, at least one contact element is preloaded by an elastic spring element that is interposed between the contact element and the associated holding element. The “associated” holding element is the first holding element in the case of the first contact element and is the second holding element in the case of the second contact element. The spring element is at least indirectly, preferably directly, in contact with the holding element and the contact element. If the contact element is displaced along the shear axis, the mechanical stress in the spring element increases. The spring element may consist for example of spring steel or fiber composite material. By contrast, the holding element and the contact element may consist of relatively inelastic material, for example hard plastics material or a steel of relatively low elasticity. The spring element may take a variety of forms, for example may be helically wound in the manner of a coil spring or may be curved in the manner of a leaf spring. Here, a side portion of the spring element may be supported on the holding element, whilst a middle portion is supported on the contact element. The spring element may be received in a recess of the holding element, in which recess the contact element is also at least partially received.

The preload of the contact element may be fixedly defined by the design of the components involved. With a suitable design, it is thus possible for the first torsional natural frequency to be shifted into a range that is sufficiently far removed from the vertical wheel vibration frequency. Deviations may however arise here owing to different influences such as manufacturing and assembly tolerances. It would furthermore also be conceivable to use one coupling device in different variants of a vehicle model or even in different vehicle models. Different torsional natural frequencies may then arise depending on the variant or model. For these and other reasons, it is preferable for a preload of a contact element to be adjustable by means of at least one adjusting element. The adjusting element may interact directly or indirectly with the contact element. In particular, said adjusting element may interact with a spring element, which in turn acts on the contact element. Said adjusting element may for example be interposed between holding element and spring element. Refinements are however conceivable in which the adjusting element is integrated into one of the other elements, for example the spring element. One possibility consists in the adjusting element being designed as a threaded element. Said adjusting element may act by way of one end on the spring element, wherein the position of the adjusting element is variable by means of a screw motion. In particular, the holding element may have an associated threaded bore that the adjusting element is fully or partially screwed into. Depending on the embodiment, it is also possible for a plurality of adjusting elements to be provided for one contact element or for one spring element.

Both the amplitude and the natural frequency of the first torsion mode can be influenced by a damping means. For this purpose, in one advantageous refinement, the second coupling part has at least one damper element which is deformable by deflection of a contact element in order to convert kinetic energy into heat. The damper element may be formed for example from an elastomer which, whilst storing a certain proportion of kinetic energy in recoverable form as deformation energy, also non-recoverably converts a proportion into heat. In other embodiments, the damper element could also have a liquid-filled cavity, wherein a deformation of the damper element leads to turbulence in the liquid, which in turn consumes kinetic energy. The damper element may for example be interposed between the contact element and the holding element, between the contact element and the spring element, between the spring element and the holding element, or the like. Said damper element may also be connected only to the spring element or, if this deforms during a deflection, only to the contact element, such that said damper element deforms conjointly. It would also be conceivable for the damper element to be integrated for example into the spring element or the contact element. In this case, the damper element is arranged such that a deflection of the contact element leads to the deformation of the damper element. It is also possible for a plurality of damper elements to be provided.

The middle element may have an inner contact surface via which it interacts with an outer contact surface of a contact element, wherein at least one of the contact surfaces extends obliquely with respect to the shear axis. A transmission of force between middle element and contact element occurs via the contact surfaces. The form fit is thus also established, at least in part, by way of the contact surfaces. For this purpose, it would be possible for the contact surfaces to extend perpendicularly to the shear axis. Accordingly, the coupling is also established only in the direction of the shear axis. In the embodiment described here, at least one of the contact surfaces, preferably both contact surfaces, extend(s) obliquely with respect to the shear axis. A transmission of force and coupling are thus possible with an additional component perpendicular to the shear axis. In particular, each contact surface may be inclined in an opening direction in which at least one of the bodyshell elements is movable out of the closed position. In the case of a rear door that is pivotable about a vertical pivot axis, the opening direction corresponds to the vehicle longitudinal axis. A transmission of force can be made possible in different directions depending on the inclination of the contact surface. For example, an inner contact surface may be inclined toward the first bodyshell element. Said inner contact surface can thus transmit forces that pull the first bodyshell element toward the second bodyshell element. Alternatively or in addition, an inner contact surface may be inclined away from the first bodyshell element, such that said inner contact surface can transmit forces that push the first bodyshell element away from the second bodyshell element. In the latter case in particular, it is advantageous if a further inner contact surface is inclined toward the first bodyshell element, such that, overall, forces can be transmitted in both directions.

In particular if one of the inner contact surfaces is inclined as described above, it is under certain circumstances not possible to move the middle element into the position between the contact elements, and out of said position, by opening and closing the door assembly. The inclination of the contact surface may specifically serve to establish a form fit in the direction in which the first bodyshell element together with the middle element moves during the opening movement. For example, the shear axis may extend in the direction of the vehicle vertical axis, whilst the opening direction at the start of the opening movement corresponds to the vehicle longitudinal axis. This be resolved by virtue of at least the middle element being adjustable relative to the first bodyshell element transversely with respect to the shear axis, whereby the form fit with the contact elements can be selectively established and eliminated. The displaceability is preferably provided not only transversely with respect the shear axis but also transversely with respect to the opening direction. In the example just mentioned, that middle element would accordingly be movable in the direction of the vehicle transverse axis. It is possible for only the middle element, or the first coupling part as a whole, to be displaceable. The displacement may be initiated by means of a mechanism that unlocks and locks the door assembly.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

For a better understanding of the present disclosure, reference may be made to embodiments shown in the following drawings. The components in the drawings are not necessarily to scale and related elements may be omitted, or in some instances proportions may have been exaggerated, so as to emphasize and clearly illustrate the novel features described herein. In addition, system components can be variously arranged, as known in the art. Further in the figures, like referenced numerals refer to like parts throughout the different figures.

FIG. 1 shows a side view of a road vehicle;

FIG. 2 shows a rear view of the road vehicle from FIG. 1 having a first embodiment of a door assembly according to an exemplary embodiment of the present disclosure;

FIG. 3 is a sectional illustration of the door assembly from FIG. 2 corresponding to the line III-III in FIG. 2;

FIG. 4 is a sectional illustration corresponding to the line IV-IV in FIG. 3;

FIG. 5 is a sectional illustration corresponding to FIG. 4 of a of a door assembly according to another exemplary aspect of the present disclosure;

FIG. 6 is a sectional illustration corresponding to FIG. 4 of a door assembly according to yet another exemplary aspect of the present disclosure;

FIG. 7 is a sectional illustration corresponding to FIG. 4 of a door assembly according to yet another exemplary aspect of the present disclosure;

FIG. 8 is a sectional illustration corresponding to FIG. 3 of a door assembly according to yet another exemplary aspect of the present disclosure;

FIG. 9 is a sectional illustration corresponding to FIG. 3 of a door assembly according to yet another exemplary aspect of the present disclosure;

FIG. 10 is a sectional illustration corresponding to FIG. 3 of a door assembly according to yet another exemplary aspect of the present disclosure; and

FIG. 11 shows a rear view of a further road vehicle having a door assembly according to yet another exemplary aspect of the present disclosure.

### DETAILED DESCRIPTION

In the various figures, identical parts are always denoted by the same reference signs, for which reason said parts will generally also be described only once.

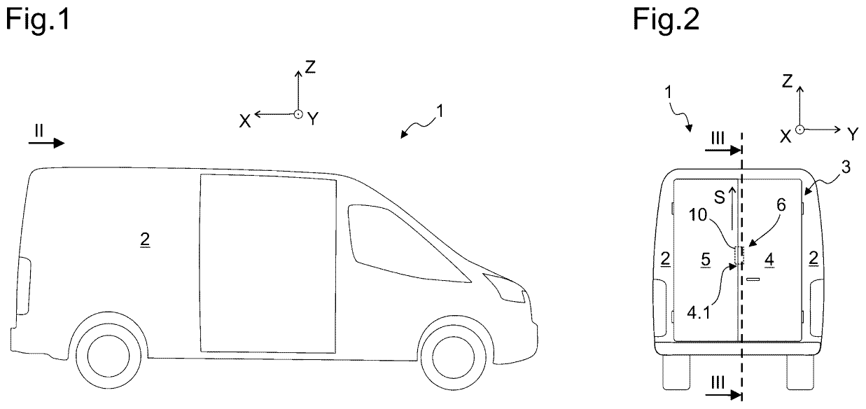

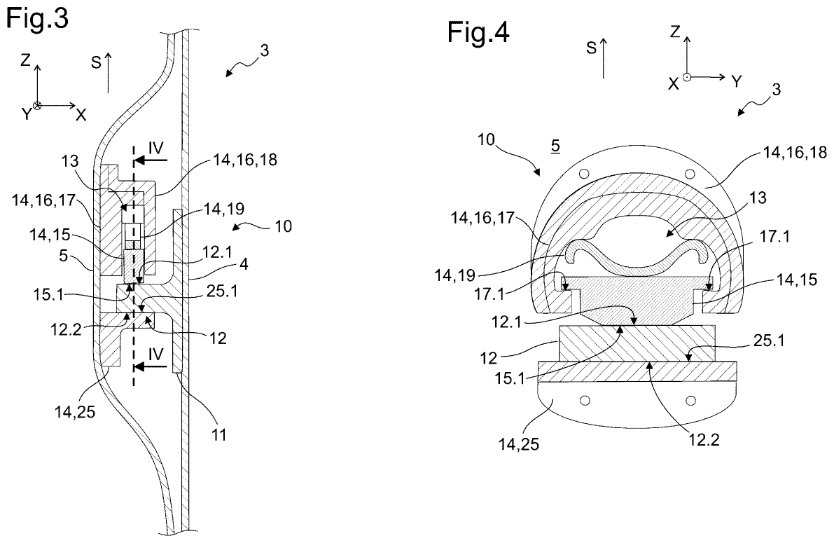

FIGS. 1 and 2 show a road vehicle 1, in this case a delivery van, having a vehicle body 2 on which a door assembly 3 is arranged at a rear end in relation to a longitudinal axis X. Said door assembly has a first bodyshell element 4 designed as a first door element and has a second bodyshell element 5 designed as a second door element. These will hereinafter also be referred to for short as first door 4 and second door 5. In FIGS. 1 and 2, the doors 4, 5 are closed. The door assembly 3 is accordingly in a closed position. A contour 4.1 of the first door 4 extends, in a shear region 6, parallel to a shear axis S. Said shear axis extends in this case parallel to a vertical axis Z of the road vehicle 1, the vertical axis being shown in the figures together with a transverse axis Y and the longitudinal axis X. FIG. 2 schematically shows a coupling device 10, which will be described below with reference to FIGS. 3 and 4.

The coupling device 10 has a first coupling part 11, which is connected to the first door 4 and has a middle element 12. Said middle element projects from the first door 4 in the direction of the longitudinal axis X. A second coupling part 14 is connected to the second door 5. Said second coupling part has a first holding element 16 which is rigidly connected to the second door 5, for example by means of screws. In this case, said second coupling part is assembled from two elements, namely a base 17 and a housing 18, and defines a recess 13. A spring element 19 is received in said recess 13, and so too are parts of a first contact element 15. The spring element 19 is designed as a leaf spring and is supported at one side on the holding element 16 and at the other side on the first contact element 15. The preload of the spring element 19 causes the first contact element 15 to be held in contact with the middle element 12. More specifically, a first outer contact surface 15.1 lies against a first inner contact surface 12.1 under preload. The middle element 12 furthermore lies with a second inner contact surface 12.2 against a second outer contact surface 25.1 of a second contact element 25. Said second contact element is rigidly connected to the second door.

In the closed position the first contact element 15 is deflected slightly, counter to the action of the spring element 19, by the middle element 12. This is possible owing to the freedom of movement of the first contact element 15 within the recess 13. If the middle element 12 moves out of the region between the contact elements 15, 25, the first contact element 15 is forced by the spring element 19 against two retaining portions 17.1 of the base 17.

If the first contact element 15 is forced by the spring element 19 against the middle element 12, this can result in a slight deflection of the middle element 12, possibly together with the entire first coupling part 11 and the first door 4, whereby the middle element 12 is forced into contact with the second contact element 25. This has the overall result that the middle element 12 is enclosed on both sides between the contact elements 15, 25. This in turn results in defined coupling between the doors 4, 5, which influences a natural frequency of a first global torsion mode of the road vehicle 1.

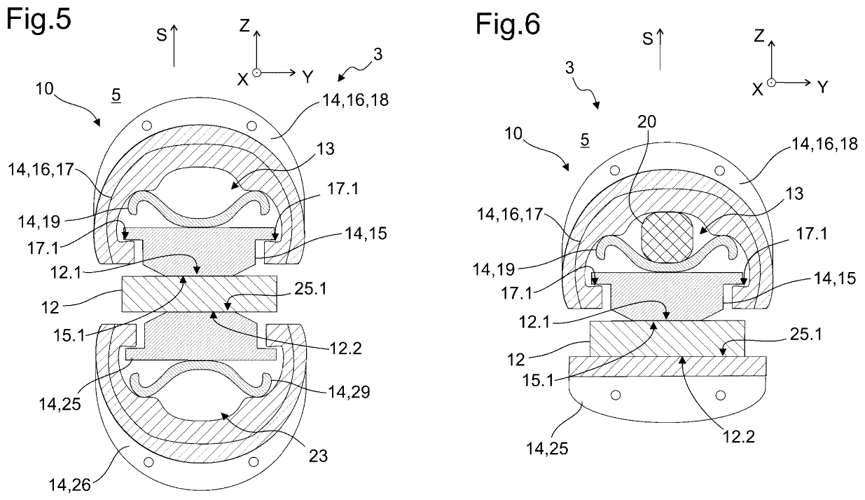

FIG. 5 shows a second embodiment of a door assembly 3 according to another exemplary aspect of the present disclosure, which substantially corresponds to the first embodiment and in this respect will not be discussed once again. In this case, the second coupling part is of symmetrical design. The second contact element 25 is received in a recess 23 of a second holding element 26, together with a second spring element 29. Both contact elements 15, 25 are preloaded against the middle element 12.

FIG. 6 shows a third embodiment of a door assembly 3 according to yet another exemplary aspect of the present disclosure, which again substantially corresponds to the first embodiment. In this case, a damper element 20 is interposed between the spring element 19 and the first holding element 16. Said damper element may for example consist of rubber. In the event of a deflection of the first contact element 15, the damper element 20 is deformed, whereby kinetic energy is partially converted into heat. In this way, both the amplitude of the first global torsion mode can be reduced and the natural frequency thereof can be further influenced.

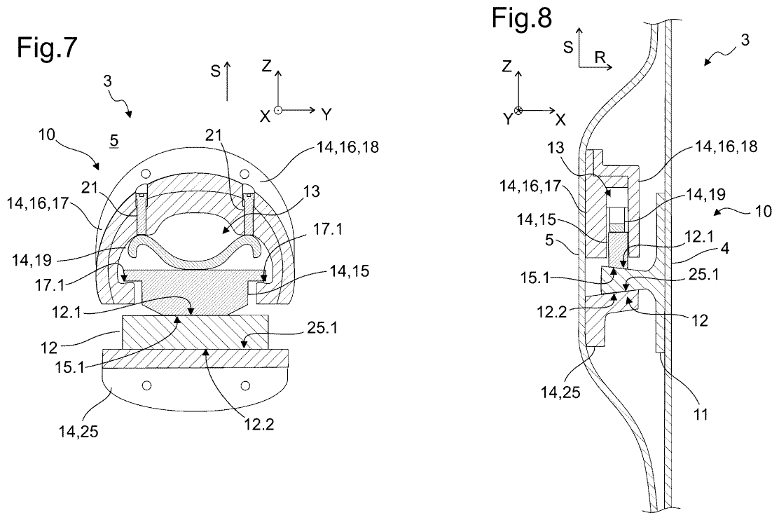

FIG. 7 shows a fourth embodiment of a door assembly 3 according to yet another exemplary aspect of the present disclosure, which again substantially corresponds to the first embodiment. However, the preload of the spring element 19 can be influenced by means of two adjusting elements 21. The adjusting elements 21 are designed as screws, which are screwed into threaded bores in the holding element 16. If the adjusting elements 21 are screwed in further, the preload of the spring element 19 is increased, and so too is that of the first contact element 15.

FIG. 8 shows a fifth embodiment of a door assembly 3 according to yet another exemplary aspect of the present disclosure. This differs from the first embodiment in that the inner contact surfaces 12.1, 12.2 extend not perpendicularly but obliquely with respect to the shear axis S. Accordingly, they also do not extend parallel to an opening direction R in which the first door 4 moves away from the second door 5 during the opening movement. In this way, a force component extending parallel to the opening direction R and thus parallel to the longitudinal axis X is also generated between the inner contact surfaces 12.1, 12.2 and the outer contact surfaces 15.1, 25.1. Depending on the inclination of the inner contact surfaces 12.1, 12.2, it is thus possible to prevent the middle element 12 from being able to be led out from between the contact elements 15, 25 in the opening direction R. Provision may therefore be made for at least the middle element or else the entire first coupling part 11 to be displaceable relative to the first door parallel to the transverse axis Y. The displacement may be effected by means of a locking mechanism that is not illustrated here.

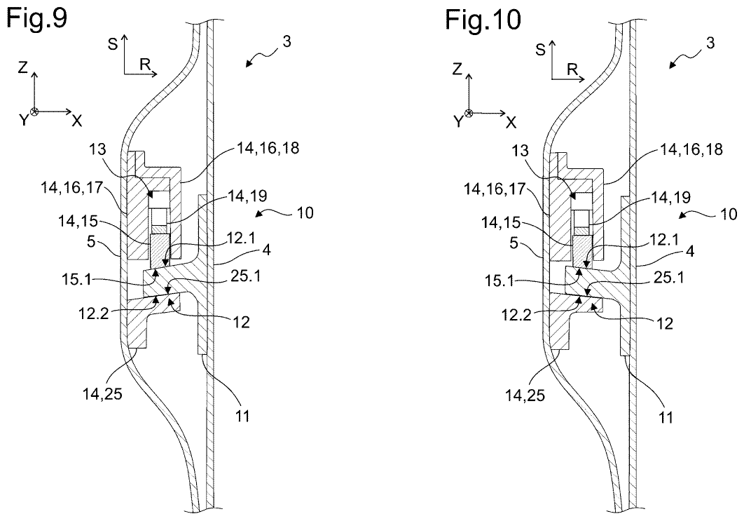

FIGS. 9 and 10 show a sixth and a seventh embodiment of a door assembly according to still other exemplary aspects of the present disclosure, which each substantially correspond to the fifth embodiment. Whilst both inner contact surfaces 12.1, 12.2 are inclined toward the first door 4 in the fifth embodiment, it is the case in the sixth embodiment that the first inner contact surface 12.1 is inclined away from the first door 4, and in the seventh embodiment that the second inner contact surface 12.2 is inclined away from said first door. It is self-evident that, in the sixth and seventh embodiments, the contact elements 15, 25 impart two opposite force components along the longitudinal axis X via the first and second contact surfaces 12.1, 12.2. Displacements of the doors 4, 5 in both directions along the longitudinal axis X are thus counteracted.

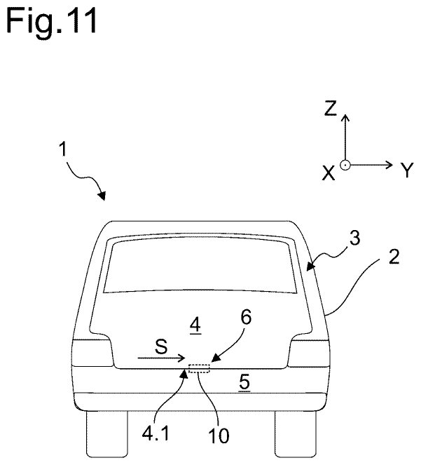

FIG. 11 shows a rear view of a further road vehicle 1 having an eighth embodiment of a door assembly 3 according to still other exemplary aspects of the present disclosure. In this case, the first bodyshell element 4 is formed by a tailgate that can be pivoted upward in order to be opened. The second bodyshell element 5 is connected in static fashion to the vehicle body 2 and forms a lower load sill. In this case, the shear axis S extends parallel to the transverse axis Y. The coupling device 10, which is illustrated only schematically here, may take a variety of forms, for example may be designed according to one of the first to seventh embodiments.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A door assembly for a road vehicle, comprising:
a first bodyshell element and a second bodyshell element, at least one of which is configured as a door element wherein, in a closed position, a contour of the first bodyshell element extends, in a shear region, adjacent to the second bodyshell element along a shear axis; and
a coupling device comprising a first coupling part connected to the first bodyshell element and a second coupling part connected to the second bodyshell element, wherein, in the closed position, a middle element of the first coupling part is received, on both sides with respect to the shear axis, in a form-fitting manner between a first contact element and a second contact element of the second coupling part, wherein a preload is established between the middle element and at least one of the first contact element or the second contact element.

2. The door assembly of claim 1, wherein the shear axis extends at an angle with respect to a vehicle longitudinal axis, the angle being from about 60 degrees to about 90 degrees.

3. The door assembly of claim 1, wherein the second coupling part comprises a first holding element fixed in position on the second bodyshell element with respect to the shear axis, and the first contact element is deflectable along the shear axis and preloaded in a direction of the middle element relative to the first holding element.

4. The door assembly of claim 3, wherein the second coupling part comprises a second holding element fixed in position on the second bodyshell element with respect to the shear axis, and the second contact element is deflectable along the shear axis and preloaded in the direction of the middle element relative to the second holding element.

5. The door assembly of claim 4, wherein the first and second holding elements are mirror-symmetrical with respect to the shear axis.

6. The door assembly of claim 1, wherein the second contact element is fixed in position on the second bodyshell element with respect to the shear axis.

7. The door assembly of claim 1, further comprising at least one adjusting element configured to adjust a preload of a contact element.

8. The door assembly of claim 1, wherein the middle element comprises an inner contact surface configured to interact with an outer contact surface of at least one of the first contact element or the second contact element, and at least one of the inner contact surface or the outer contact surface extends obliquely with respect to the shear axis.

9. The door assembly of claim 1, wherein at least the middle element is adjustable relative to the first bodyshell element transversely with respect to the shear axis, such that a form fit with at least one of the first contact element or the second contact element can be selectively established and eliminated.

10. The door assembly of claim 1, wherein at least one of the first contact element or the second contact element is preloaded by an elastic spring element disposed between the at least one of the first contact element or the second contact element and an associated holding element.

11. The door assembly of claim 10, wherein the elastic spring element comprises a leaf spring, a coil spring, or a fiber composite spring.

12. The door assembly of claim 1, wherein the second coupling part comprises at least one damper element deformable by deflection of a contact element to convert kinetic energy into heat.

13. The door assembly of claim 12, wherein the damper element comprises an elastomeric material or a liquid-filled cavity.

14. The door assembly of claim 1, wherein the coupling device is configured such that the preload between the middle element and the contact element is maintained during vehicle operation.

15. The door assembly of claim 1, wherein the first coupling part is movable relative to the first bodyshell element in a direction transverse to the shear axis.

16. The door assembly of claim 1, wherein the coupling device is configured to shift a natural frequency of a torsional vibration mode of the road vehicle outside a range of a vertical wheel vibration frequency.

17. The door assembly of claim 1, wherein the first and second contact elements are symmetrically arranged with respect to the shear axis.

18. The door assembly of claim 1, wherein the coupling device further comprises a locking mechanism configured to selectively establish or eliminate a form fit between the middle element and the contact elements.

19. The door assembly of claim 1, wherein the first bodyshell element is configured as a tailgate, and the second bodyshell element is configured as a load sill.

20. A method of limiting torsional vibrations in a road vehicle, comprising:
providing a door assembly according to claim 1; and
configuring the coupling device such that, in the closed position, the middle element is form-fittingly received between the first and second contact elements, and at least one of the contact elements and the middle element are preloaded against one another.
